(19) United States
(12) Patent Application Publication
(10) Pub. No.: US 2007/0256512 A1
(43) Pub. Date: Nov. 8, 2007

(54) Speed Reducing Mechanism

(76) Inventor: Chung-Chuan LIN, Taiping Taichng Hsien (TW)

Correspondence Address: BANGER SHIA, 204 CANYON CREEK, VICTORIA, TX, 77901, US

(21) Appl. No.: 11/533,333

(22) Filed: Sep. 19, 2006

(30) Foreign Application Priority Data
May 2, 2006 (TW) 095207494

(51) Int. Cl. F16H 21/48

(52) U.S. Cl. 74/63

(57) ABSTRACT

The speed reducing mechanism comprises a housing, a power shaft, a bevel gear set, a drive shaft and a driven shaft. The power shaft, the drive shaft and the driven shaft are pivotally disposed in the housing, and the drive shaft is vertically connected to the driven shaft via the bevel gear set. The bevel gear and the bevel fluted disc of the bevel gear set are meshed with each other at a displacement angle. By such arrangements, the transmission efficiency of the speed reducing mechanism can be increased to 85-95%.

### BACKGROUND OF THE INVENTION

1. Field of the Invention

The present invention relates to a speed reducing mechanism, and more particularly to a speed reducing mechanism that can increase the transmission efficiency up to 85-95%.

2. Description of the Prior Art

Speed reducing mechanism is one of indispensable components for a vehicle or machines of the like, it is particularly used to reduce the speed of a motor and to cooperatively control the torque output. Therefore, a motor above 1800 rpm must be equipped with a stable and non-oil leakage speed reducing mechanism.

Conventional speed reducing mechanism usually has the function absorbing the inertia of the load and improving the motor's toque. As shown in FIG. 1, a conventional speed reducing mechanism comprises a housing 10, a power shaft 11, a worm gear set 12, a drive shaft 13, and a driven shaft 14. The driven shaft 14 is pivotally inserted through the housing 10. The drive shaft 13 is vertically connected to the driven shaft 14 via the worm gear set 12. The worm gear set 12 includes a worm shaft 121 is meshed tangently with a worm 122. The housing 10 is defined with a power-input hole 101 and a power output hole 102. This conventional product has the following disadvantages:

The drive shaft 13 is vertically connected to the driven shaft 14 via the worm gear set 12, the worm shaft 121 is tangently meshed with the worm 122. however, the technique of the worm shaft 121 tangetly meshing with the worm 122 is to convert rotation into an axial feed, and then to convert the axial feed into rotary feed. Hence, the conventional speed reducing mechanism has a relatively large energy loss, and the transmission efficiency of the worm shaft 121 is as low as 75%.

The present invention has arisen to mitigate and/or obviate the afore-described disadvantages.

### SUMMARY OF THE INVENTION

The primary objective of the present invention is to provide a speed reducing mechanism that can improve the transmission efficiency up to 85-95%.

To obtain this objective, the speed reducing mechanism in accordance with the present invention comprises a housing, a power shaft, a bevel gear set, a drive shaft and a driven shaft. The power shaft, the drive shaft and the driven shaft are pivotally disposed in the housing, and the drive shaft is vertically connected to the driven shaft via the bevel gear set. The bevel gear and the bevel fluted disc of the bevel gear set are meshed with each other at a displacement angle. By such arrangements, the transmission efficiency of the speed reducing mechanism can be improved up to 85-95%.

### BRIEF DESCRIPTION OF THE DRAWINGS

FIG. 1 is a cross sectional view of a conventional speed reducing mechanism;

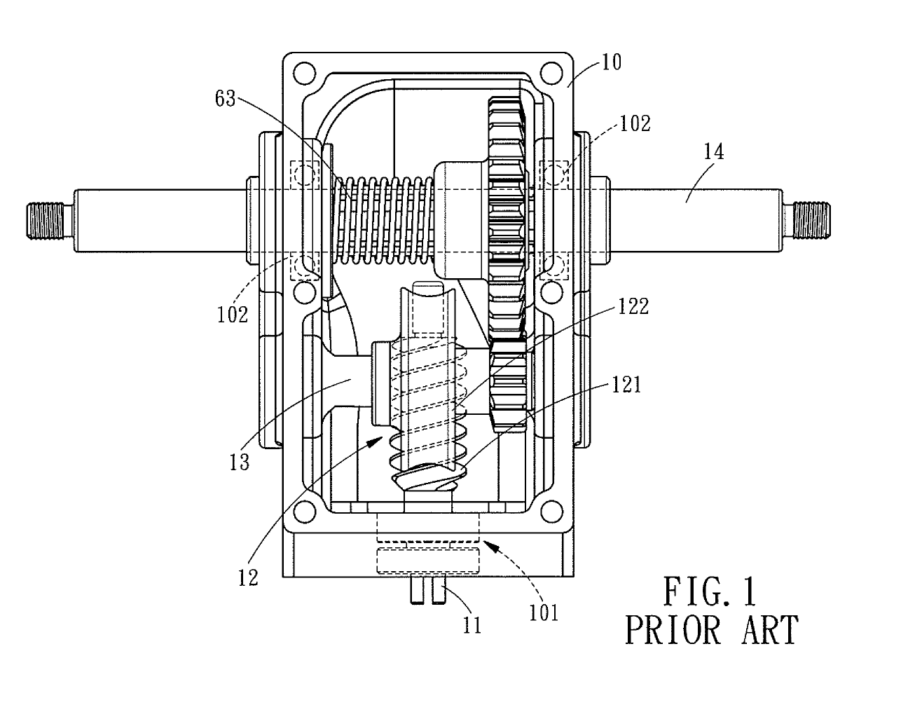

FIG. 2 is a cross sectional view of a speed reducing mechanism in accordance with the present invention;

FIG. 3 is an illustrative view of the speed reducing mechanism in accordance with the present invention; and

FIG. 4 shows the interior arrangement of the speed reducing mechanism in accordance with the present invention.

### DETAILED DESCRIPTION OF THE PREFERRED EMBODIMENT

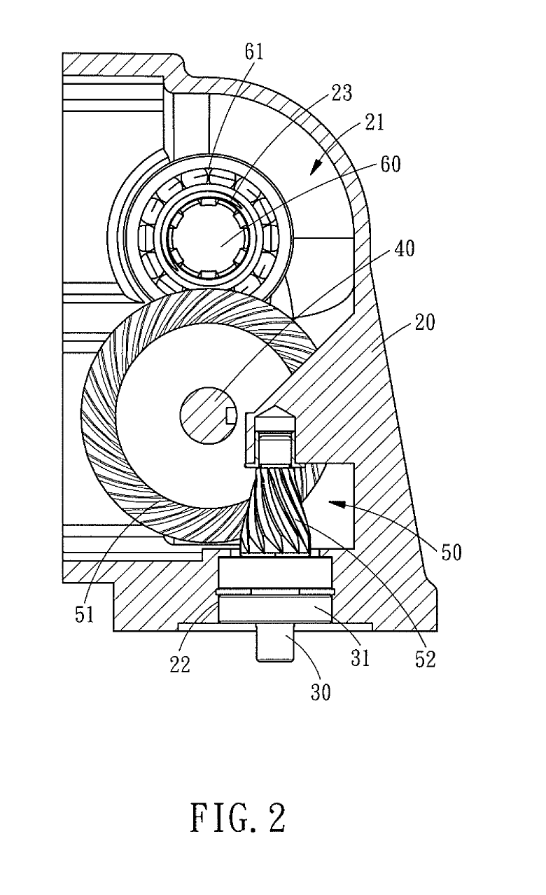

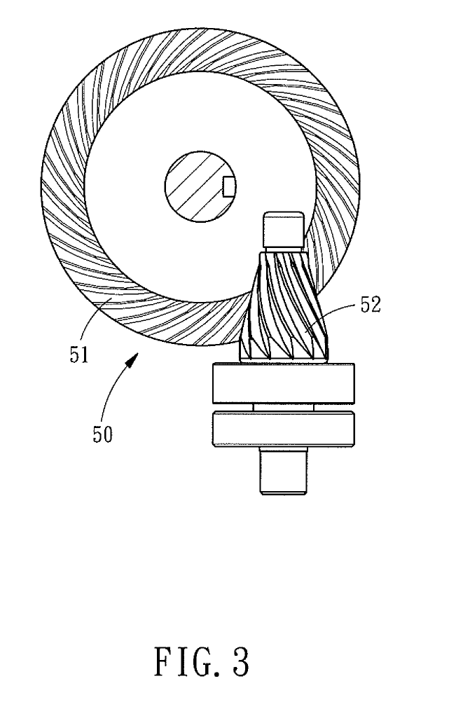

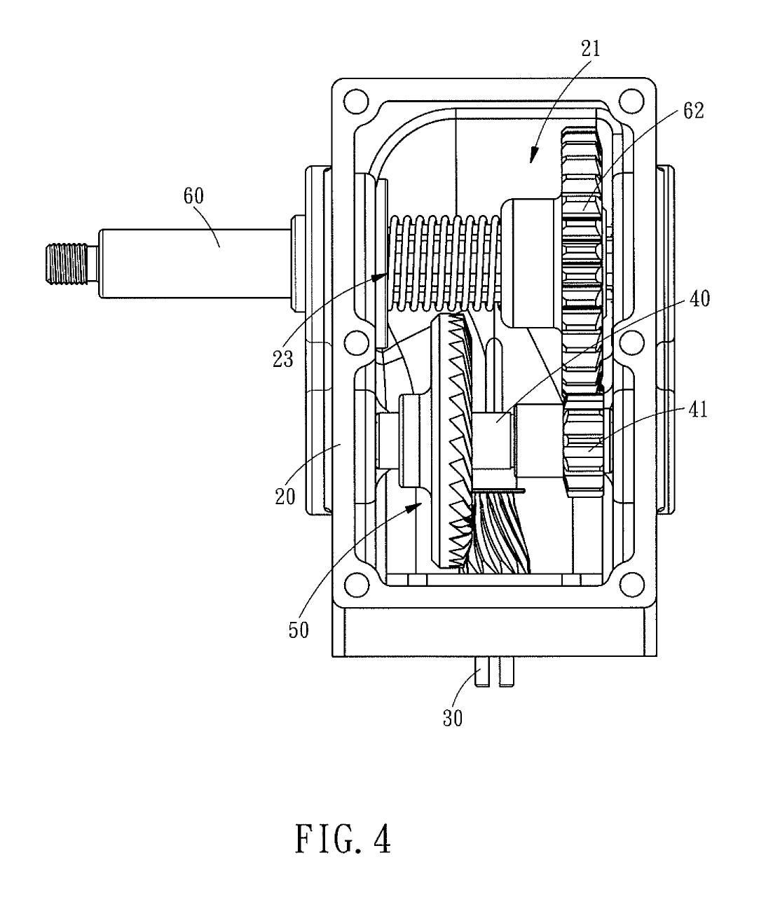

The foregoing, and additional objects, features and advantages of the present invention will become apparent from the following detailed description of preferred embodiments thereof, taken in conjunction with the accompanying FIGS. 2-4.

A speed reducing mechanism in accordance with the present invention comprises a housing 20, a power shaft 30, a drive shaft 40, a bevel gear set 50 and a driven shaft 60.

The housing 20 includes a plurality of parts and is defined with a receiving space 21, a power input hole 22 and a power output hole 23. The power input hole 22 is vertical to the power output hole 23.

The power shaft 30 has one end connected to a predetermined power source and another end inserted in the receiving space 21 of the housing 20 via the power output hole 22. A plurality of bearings 31 is arranged between the power shaft 30 and the housing 20.

The drive shaft 40 is installed in the receiving space 21 of the housing 20 and is vertical to the power shaft 30. A pinion 41 is provided on the drive shaft 40.

The bevel gear set 50 includes a bevel fluted disc 51 and a bevel gear 52 and is installed in the receiving space 21 of the housing 20. The bevel fluted disc 51 is coaxially installed on the drive shaft 40, the bevel gear 52 is coaxially fixed at the end of the power shaft 30, and the bevel gear 52 is engaged with the bevel fluted disc 51, so that the rotary power of the bevel fluted disc 52 can rotate the bevel gear 51 directly.

The driven shaft 60 has one end connected to a predetermined component to be driven, and the other end inserted through the power output hole 23 into the receiving space 21 of the housing 20. The driven shaft 60 is parallel to the drive shaft 40, and a plurality of bearings 61 is provided between the driven shaft 60 and the drive shaft 40. A gear wheel 62 cooperating with a spring 63 is slideably installed on the driven shaft 60 and is to be engaged with the pinion 41 of the drive shaft 40, and the spring 63 is biased between the gear wheel 62 and the housing 20. The gear wheel 62 cooperates with the spring 63 to serves a clutch (this is a conventional technique, and further explanations will be omitted).

For a better understanding of the function and operation of the speed reducing mechanism, reference should be made to the following descriptions:

The power shaft 30 has one end connected to a predetermined power source, and another end inserted through the power input hole 22 and into the receiving space 21 of the housing 20, therefore, the power shaft 30 cooperates with the bearings 31 to produce a rotating force. At this moment, the bevel gear 52 of the bevel gear set 50 is engaged with the bevel fluted disc 51, and is subjected to the rotating force of the power shaft 30, so it can rotate the bevel fluted disc 51 directly. Furthermore, the bevel gear 52 of the bevel gear set 51 is engaged with the bevel fluted disc 51 at an angle, so it can transmit the power directly by rotation (without converting the axial displacement). In this way, the transmission efficiency of the speed reducing mechanism of the present invention can be increased up to 85-95%.

On the other hand, when the bevel fluted disc 51 rotates the drive shaft 40, the pinion 41 of the drive shaft 40 is engaged with the gear wheel 62, and the gear wheel 62 drives the driven shaft 60 to rotate, so that the power is output from another end of the driven shaft 60 via the power output hole 23.

The displacement angle of the bevel gear 52 of the bevel gear set 50 with respect to the bevel fluted disc 51 can be adjusted as desired. When the angle of displacement is reduced (the meshing position of the bevel gear 52 is more close to the central axis of the bevel fluted disc 51), the transmission efficiency is close to 95%, and the torque is relatively small. When the displacement angle increases (the meshing position of the bevel gear 52 is relatively far away from the central axis of the bevel fluted disc 51), the transmission efficiency is approximately 85%, and the resultant torque is relatively large. Besides, the present invention is also applicable to the conventional driven shaft having two power output holes.

To summarize, the speed reducing mechanism in accordance with the present invention comprises a housing, a power shaft, a bevel gear set, a drive shaft and a driven shaft. The power shaft, the drive shaft and the driven shaft are pivotally disposed in the housing, and the drive shaft is vertically connected to the driven shaft via the bevel gear set. The bevel gear and the bevel fluted disc of the bevel gear set are meshed with each other at a displacement angle. By such arrangements, the transmission efficiency of the speed reducing mechanism can be improved to 85-95%.

While we have shown and described various embodiments in accordance with the present invention, it is clear to those skilled in the art that further embodiments may be made without departing from the scope of the present invention.

What is claimed is:

1. A speed reducing mechanism comprising a housing, a power shaft, a drive shaft, a bevel gear set, and a driven shaft; wherein:
the housing;
the power shaft has one end connected to a predetermined power source, and another end pivotally inserted in the housing;
the drive shaft is disposed in the housing and provided with a pinion;
the bevel gear set includes a bevel gear and a bevel fluted disc and is disposed in the housing, the bevel fluted disc is coaxially fixed on the drive shaft, the bevel gear is coaxially fixed at an end of the power shaft, the bevel gear is engaged with the bevel fluted disc at a displacement angle, so that the bevel gear can rotate the bevel fluted disc directly; and
the driven shaft has one end connected to a predetermined component to be driven, and another end inserted in the housing.

2. The speed reducing mechanism as claimed in claim 1, wherein a power output hole and a power input hole are defined in the housing, and the power input hole is vertical to the power output hole, the one end of the power shaft is inserted through the power input hole into the housing, and the driven shaft is inserted through the power output hole into the housing.

3. The speed reducing mechanism as claimed in claim 1, wherein the drive shaft is disposed in a receiving space of the housing and is vertical to the power shaft, and the driven shaft is parallel to the drive shaft.

4. The speed reducing mechanism as claimed in claim 2, wherein the drive shaft is disposed in a receiving space of the housing and is vertical to the power shaft, and the driven shaft is parallel to the drive shaft.

5. The speed reducing mechanism as claimed in claim 1, wherein the driven shaft is provided with a spring to be biased between a gear wheel and the housing, and the spring cooperates with the gear wheel to serve as a clutch.

6. The speed reducing mechanism as claimed in claim 2, wherein the driven shaft is provided with a spring to be biased between a gear wheel and the housing, and the spring cooperates with the gear wheel to serve as a clutch.

7. The speed reducing mechanism as claimed in claim 3, wherein the driven shaft is provided with a spring to be biased between a gear wheel and the housing, and the spring cooperates with the gear wheel to serve as a clutch.

8. The speed reducing mechanism as claimed in claim 4, wherein the driven shaft is provided with a spring to be biased between a gear wheel and the housing, and the spring cooperates with the gear wheel to serve as a clutch.
